(19) United States
(12) Patent Application Publication
(10) Pub. No.: US 2025/0301415 A1
(43) Pub. Date: Sep. 25, 2025

(54) SPACE RADIO FREQUENCY INTERFERENCE PROVISIONING IN CONTACT PLANNING

(71) Applicant: Raytheon Company, Tewksbury, MA (US)

(72) Inventors: Jared B. Dorny, Aurora, CO (US); Vincent A. Pascente, Denver, CO (US); Varian S. Little, AURORA, CO (US); Zachariah N. Wells, BROOMFIELD, CO (US); Timothy R. Johnson, Bennett, CO (US)

(21) Appl. No.: 18/614,042

(22) Filed: Mar. 22, 2024

(51) Int. Cl. H04W 52/26; H04B 17/391

(52) U.S. Cl. CPC H04W 52/26; H04B 17/3912; H04B 17/3913

(57) ABSTRACT

A contact planning system can include memory for storing orbit and transmission data for space and ground objects. The system can further include a processing system coupled to the memory. The processing system can determine which of the space and ground objects are within a field of view of a receive antenna based on geometric calculations, to generate a set of potential interferers. The processing system can further compare transmission parameters of the set of potential interferers with corresponding parameters for an intended emitter to determine which of the set of potential interferers are expected to generate at least a threshold interference level. The processing system can further prepare an avoidance plan for avoiding interference with potential interferers that are expected to exceed the threshold interference level. Other apparatuses and methods are also described.

### TECHNICAL FIELD

The present disclosure generally relates to interference avoidance, and more specifically, to prediction of likely interferers and contact planning to avoid interferers.

### BACKGROUND

Satellites are used for many military and civilian purposes, such as for navigation, reconnaissance, relaying of communications, tracking the weather, and the like. A satellite typically carries radio equipment for connecting to a ground station and other satellites. The ground station may be positioned between the satellite and one or more operator terminals, and may be configured to relay data between the satellite and the operator terminals.

In an increasingly crowded and complex space environment, a spacecraft (e.g., a satellite) requires the ability to autonomously plan and avoid Radio Frequency (RF)/Electromagnetic Interference events in real time.

Currently, Radio Frequency Interference (RFI), or Electromagnetic Interference (EMI) events are planned for in advance and generally based on past detection and classification. Typically, spacecrafts can only react to pre-planned, known events that have been uploaded. Moreover, conventional spacecraft systems do not perform autonomous avoidance planning.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 depicts an environment for RF interference prediction and avoidance, according to some embodiments of the disclosure.

FIG. 2 shows an exemplary system for space RFI provisioning and contact planning, according to some embodiments of the disclosure.

FIG. 3 shows an exemplary half cone overlap of two transmitting antennas, according to some embodiments of the disclosure.

FIG. 4 illustrates antenna patterns and off axis gains according to some aspects of the disclosure.

FIG. 5 illustrates an example display with scored list according to aspects of the disclosure.

FIG. 6 is a flow chart of an example method according to embodiments.

FIG. 7 is a diagrammatic representation of a machine in the form of a computer system within which a set of instructions may be executed to cause the machine to perform any one or more of the methodologies discussed herein, according to some examples.

### DETAILED DESCRIPTION

Embodiments of the present disclosure are directed to prediction and avoidance of radio frequency interference (RFI) or Electromagnetic Interference (EMI) events by using existing space catalog data, visibility generation and knowledge of transmission parameters (e.g., frequencies, power, modulation, etc.) to plan RFI/EMI avoidance. Hereinafter, the term RFI refers to RF interference and/or Electromagnetic Interference, which are treated similarly by the present disclosure. A space contact planning system is provided to schedule avoidance windows and perform other avoidance measures as described later herein. Embodiments can perform processing or pre-processing measures using multi-core processing systems. Modeling can be performed to model antennas of possible interferers or other systems when full parameter information is not available, allowing systems according to various embodiments to execute avoidance measures.

As space vehicles proliferate in near earth space, there is increased probability of RFI since there are many more potential interference sources and RF transmission from more than one can be simultaneously received at a given receiving antenna preventing intended transmission from being correctly deciphered.

The process for RFI prediction and autonomous RFI avoidance on board a spacecraft predicts upcoming RFI and autonomous avoidance, and can be expanded into other domains, such as cell carriers. In some embodiments, the process comprises utilizing a space catalog of resident space objects (RSOs), and optionally ground transceivers, with their RF capabilities (frequencies/power/volume of influence/beam pattern). Adjustments and planning can also be made with respect to celestial objects such as the moon, sun, etc. The catalog is periodically updated, and processing systems automatically perform visibility generation (or line of sight analysis) on the RSOs to periodically generate contact planning schedules or avoidance windows.

Embodiments of the present disclosure can maintain uninterrupted signals by and between aircraft, satellites, and similar vehicles or objects in orbit or in ground stations. Spacecraft (e.g., satellites) can use aspects of the disclosure to analyze potential interference (such as jamming, or other threats due to close proximity), and plan avoidances in advance by, for example, generating or following a contact plan. The interference(s) may be from a ground station transmitting to other spacecraft, from spacecraft transmitting to each other, from celestial bodies, etc. Avoidance and planning techniques can be based on known space vehicle constellations and geometry-based determination when two or more space vehicles are within a ground antenna field of view. The geometric determinations and calculations can provide guidance so the contact plan can be adjusted to avoid potential RFI and signals interception.

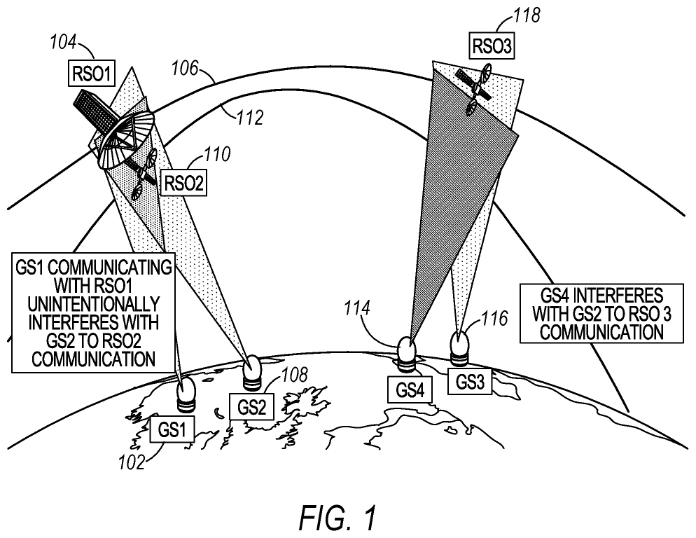

FIG. 1 depicts an environment 100 for RFI prediction and avoidance, according to some embodiments of the disclosure. As shown, a ground station 102 can be communicating with a resident space object (RSO) 104, which is moving in a travel path 106. Another ground station 108 can be communicating with RSO 110 which is moving in travel path 112. Depending on angles of communication, interference can occur wherein ground station 102 inadvertently interferes with ground station 108 communication to RSO 110. Interference caused by ground station 114 can interfere with ground station 116 communication to RSO 118. Although environment 100 depicted in FIG. 1 illustrates a ground-to-space scenario, embodiments disclosed herein may also apply to a space-to-space scenario in which a space emitter is interfering with spacecraft receiving signals from an intended space emitter.

Other examples can include jamming of communications between RSOs, caused either by ground stations, or other RSOs, or celestial bodies. For example, in one scenario, a space object can interfere with spacecraft receiving a signal from an intended space emitter. Crosslink communication can occur such that a first space object communicating to a second space object interferes with communication of a third space object that is a further distance past the second space object. In another scenario, a space emitter can interfere with a ground antenna receiving a signal from a different intended space emitter. This scenario can be relatively rare due to power restrictions of space emitters; however, interference remains a possibility. In a still further scenario, the sun (being the largest RF emitter in the solar system) can interfere, and the moon can furthermore act as an RF reflector to interfere with communications by reflecting communications into an interference path with desired communications.

Any of the ground stations or RSOs shown in FIG. 1 (it will be understood that systems are not limited to the exact configuration shown in FIG. 1) can update a space catalog stored remotely in a memory and can update the catalog when needed. The catalog can be compiled by remote computing devices from an automated survey, published and made available as computer files and can include information provided by the Space Object Data Base maintained by 18^{th} Space Defense Squadron (SDS) in the Unified Data Library (UDL), although embodiments are not limited thereto.

Embodiments of the disclosure can assess the subset of space objects that are within a receive antenna field of view by determining geometry (angles and distances) of intended emitters with respect to a potential interfering emitter and the intended ground sites. Once potential interferers are detected or determined according to this geometry, the subset of potential RFI instances can be further reduced by accounting for frequency, beamwidth, and/or transmit power of each potential interferer. The transmit power and beamwidth of potential interferers can be compared to similar parameters of the intended emitter (EIRP), with consideration made for receive antenna sensitivity (G/T) and directionality (gain variation with offset angle) as described later herein.

If the effective interference power compared to power of intended emitter is sufficiently large such that communications could be affected, those potential interferers are flagged for consideration by a contact avoidance window or contact plan. Examples of a contact plan can include avoiding a particular communication window to avoid predicted interference from a potential interferer (whether unintentional interference of intentional interference (e.g., “jamming”)). For instance, a ground station or RSO can stop transmission, change frequency, power or modulation, when the ground station or RSO determines that the transmission may be impacted by nearby RFI and then resume normal operation once it is predicted that RFI will no longer be present, etc.

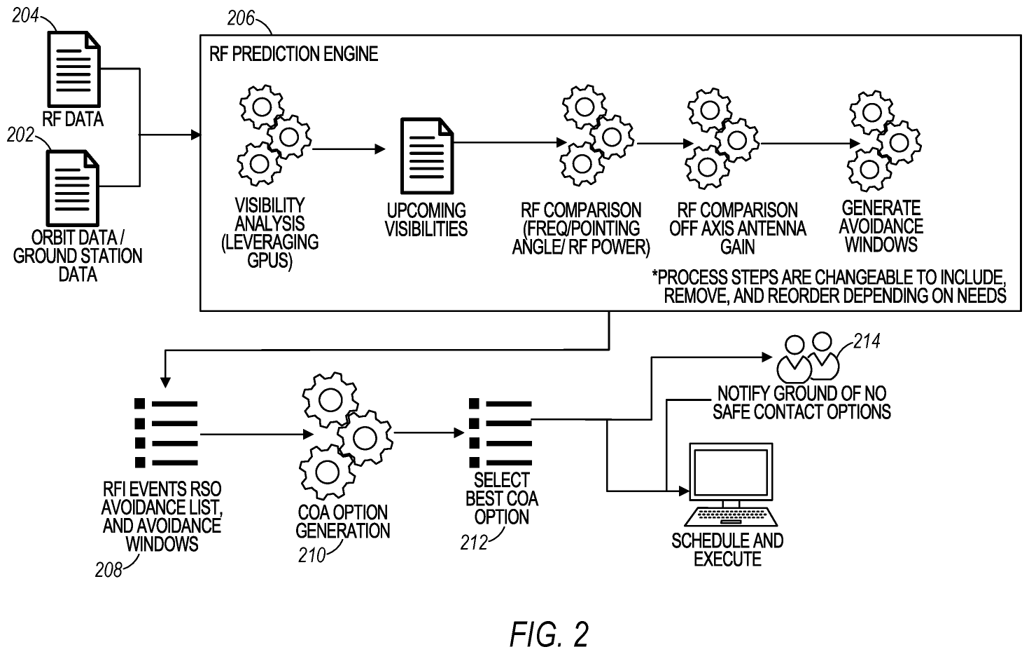

FIG. 2 shows a contact planning system 200 according to some embodiments of the disclosure. As depicted, memory can be provided for storing orbit data 202 (e.g., one or more catalogs) and transmission data 204 (RF capabilities, for example, frequency/power/volume of influence/beam pattern, and the like). This data can be provided to ground stations or other RSOs. A processing system, for example in the form of an RF prediction engine 206 can be provided in a distributed fashion at a centralized planning system or in one or more ground stations, by way of example. The RF prediction engine 206 can predict any RFI by any of the RSOs or ground stations, or celestial bodies, etc.

The RF prediction engine 206 performs a visibility generation for each RSO by using the orbit data 202, and can leverage multi-core capabilities, for example a multi-core central processing unit (CPU) or graphics processing unit (GPU). Use of GPUs and cluster computers can reduce computation time or prediction time because geometric computations can be performed in advance based on known information, leaving RF comparisons to be performed as needed later (or periodically).

The visibility generation determines the angle or orbital path of each RSO and calculates a period (window) of time that each RSO is separated by less than a predetermined threshold distance from a receiving antenna of a desired vehicle, space object, satellite, etc. In some embodiments, the visibility generation entails running a known visibility generation (e.g., a field of view determination) algorithm to perform a distance assessment, which then directly translates into a RF power model. Power models are based on a link budget analysis that considers power at a signal source and receiver and the distance between the source and receiver. Link budget can be affected, by for example, power gains and losses that a communication signal experiences in a telecommunication system, such as attenuation of the transmitted signal due to propagation, antenna gains, atmospheric losses and feedline and other losses, and amplification of the signal in the receiver or any repeaters the signal passes through. In the context of embodiments, RFI will not affect communications, and associated potential interferers may not affect communications, depending on the link budget between the pertinent RSO or ground station and the desired receive antenna.

In some embodiments, the visibility is determined based on the line-of-sight and radiation pattern of each of the RSOs. The visibility is determined to correspond to a distance between a respective RSO required to achieve an acceptable signal as received by an RF prediction engine 206. For instance, the visibility may be calculated responsive to a directivity, power level of the radiation pattern, and/or other known parameters.

When visibilities are detected, the RF prediction engine 206 checks to see whether there is a need to add any constraints, such as sun and/or moon angles and other mission-dependent constraint. In some examples, frequency information (and RFI analysis) of potential interferers may not available or may not be pertinent. For example, frequency information for any RSO belonging to or owned by certain foreign powers may not be available (because that foreign power may prevent others from accessing frequency information) or the frequency information may not be pertinent because contact with such an RSO is to be avoided regardless of operating frequency. In these and other scenarios, communication is avoided based on geometric considerations, e.g., whenever those RSOs are in a field of view of the pertinent receive antenna. If there is a known frequency of interest for intended communication and frequency information for a potential interferer is known, then further RFI analysis is performed based on the frequency/frequencies of interest. If the potential interferer is known to be incapable of operating in the frequency/frequencies of interest, then no further analysis is made of that potential interferer.

The RF prediction engine 206 performs RFI analysis by using the transmission data 204 for each RSO and comparing it with transmission data of the pertinent receive antenna for which interference is being avoided. For example, frequency, volume and/or power of each RSO is compared with those of the receive antenna to calculate frequencies or frequency ranges at which the RSOs operate and is utilized to determine RSO within a distance range of the receive antenna that operate at overlapping frequencies (e.g., within a threshold range) with the receive antenna. Key RF attributes for analysis can include frequency, directionality, transmit (TX) power of a potential interferer, TX power of intended emitter, receive (RX) antenna gain, receive antenna pointing or beamwidth, location of interferers (e.g., the interferers will typically be within the beam (or side lobes) and within an effective distance relative to intended signal direction), polarization and waveform attributes.

Received power calculations can be made based on a variety of inputs. For example, RF capabilities entry/entries can be provided for each antenna. These entries can include antenna gain; antenna diameter (e.g., measured in meters); antenna efficiency (∈) (typically in the range 0.6-0.7); antenna gain (in decibels) provided or calculated from provided diameter & Frequency, where

$$Gmax = ϵ \frac{( π D ) 2}{λ 2} ;$$

pointing loss (in decibels), which can be defined as loss due to pointing error; TX EIRP (if TX is supported); supported TX/RX frequency ranges, antenna identification or ownership information; whether the antenna is in space or on the ground; and whether the antenna supports TX, RX or both. Loss information can be included, such as free space loss, atmospheric loss, or ionospheric loss. Identification information can be provided for the frequency/frequencies to be evaluated.

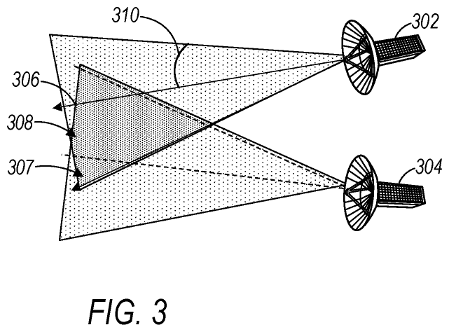

RFI analysis examines the conic intersection for RF beam simplification defined by the half cone angle of the beam. FIG. 3 shows an exemplary half cone overlap of two transmitting antennas, according to some embodiments of the disclosure. Assuming that a directional antenna 302 RF emission roughly in the shape of a cone, the direction of that cone can be defined via vector 306 in the center of the cone. The edge of the cone can also be defined with a vector 307 some angle 310 away from the center vector (rotated around to create the cone). The half angle 310 of the cone is the angle from the center vector 306 to the edge vector 307 (or the Arccosine of the Dot product of those two vectors). If the half cone angle of antenna 302 overlaps the half cone of another antenna 304, there is potential for RFI and further RFI analysis is performed as described herein.

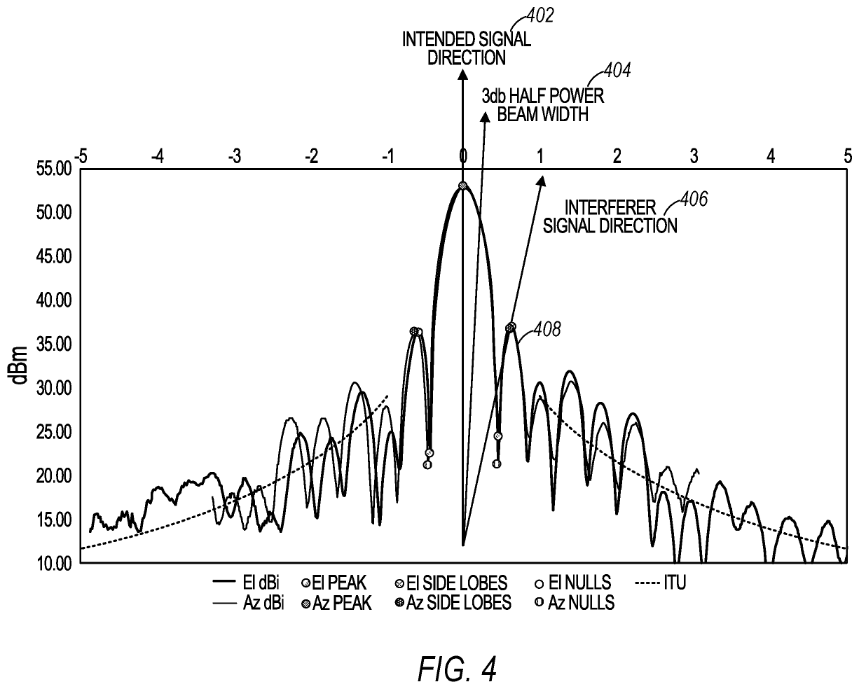

Referring again to FIG. 2, the RF prediction engine 206 can also make determinations based on off axis antenna gain. FIG. 4 illustrates antenna patterns and off axis gains according to some aspects of the disclosure. An intended signal direction is shown in direction 402 and the 3 db half power angle is shown at direction 404. However, other off axis signals (e.g., at direction 406) can still receive substantial gain when the off axis signal crosses a side lobe 408, particularly if the interferer signal is high power or the interfering object is very close to the receive antenna. Accordingly, simply using the 3 db half power angle 404 to filter may not be sufficient to filter signals in the field of view of a receive antenna and further analysis or scheduling may be required to avoid an interferer in direction 406.

Referring again to FIG. 2, if there are matching frequencies between a potential interferer and a desired receive antenna, and the volume, power and orientation potentially cause an RFI event, the RSO and visibility times are added to a list 208. An RFI event is determined for a period of time when an associated transceiver antenna and an RSO are within the visibility window, as predicted by the orbital models based on the orbit data 202 and the transmission data 204. In some embodiments, the list may include RFI events, an RSO avoidance list and avoidance windows, how long an RSO is within view, range of each RSO, and whether the RSO is between a source and target.

The RF prediction engine 206 can calculate signal power for any of the RSOs in the above list. The RF prediction engine can consider received power of both the target vehicle and the potential interferer. The received power can be determined based on the intended transmitter transmit power (TX EIRP), free space loss (FSL), and total RX power at the ground site (e.g., TX EIRP+FSL+TX Pointing Loss+Atmospheric Loss+Ionospheric Loss.

Then, the RF prediction engine 206 determine relative gain for a receive antenna, for each potential interferer, to determine if avoidance or scheduling needs to be performed. For example, the RF prediction engine 206 can use a Bessel function model when measured data is lacking or unavailable for parabolic dishes to calculate the decibels relative to carrier (dBc) difference in RX power between potential interferers and desired receive antennas. This Bessel model can be combined with position information of the target and interferer vehicle. If size of the antenna dish can be determined (e.g., through use of intelligence-generated photographs), then a model can be calculated for that antenna based on the Bessel model to calculate power levels, antenna gain patterns, and other information for the potential interferer. Then, depending on what the gain value would be in the off axis case described with respect to FIG. 4, the RF prediction engine 206 can determine if potential interference is likely to occur, and can rank potential interferers in terms of this likelihood or in some other terms such as power level, etc.

In some examples, more exact/specific information can be obtained to provide relative gain data, e.g., in obscura text format for 0-180 degrees, assuming a uniform circular radiation pattern. The RF prediction engine 206 can use this information (rather than generating a Bessel model) to generate similar interference predictions and avoidance plans based on the relative gain data.

If the list 208 is non-empty, contact avoidance systems according to example embodiments can generate course of action (COA) options 210. In some embodiments, the COA actions may include creation of an avoidance window with no transmission, switching frequencies, power, and/or modulation, using a different communication window, shorten the communication window time, and the like. A defined function can be used to score objects/potential interferers as to the likelihood of RFI.

In some embodiments, a COA scoring process 212 can be used to generate and select the best scored COA for the best course of action for avoidance (e.g., see U.S. Pat. No. 11907233B2). The selected COA can be added to remote or local scheduling system for a pertinent ground station, RSO, etc. which can notify a selected the ground or a central control system at 214. For example, the Cross Domain Mission Manager (XDM) scheduling system can rank opportunities by this score in attempt to schedule a least likely communication opportunity to have RFI (e.g., see U.S. Pat. No. 10110703B2).

Once the RFI event is past, normal (e.g., non-avoidance) operation can be resumed.

In some embodiments, the COA scoring is based on normalizing and weighing one or more factors, such as range, link margin, power, antenna size, receiver sensitivity that are provided in each of the COAs. Other factors may be added (eventual configuration) which would adjust the scoring formula to account for those factors as well. In some embodiments, the score/rank of a COA is based on a defined, and configurable, set of comparators that a control station needs to perform a mission for a pertinent device or vehicle. Reducing this selection time and lowering the error rate, while providing an adaptable RF and/or EM agnostic system is critical to mission success.

In some embodiments, the COA scoring accepts RF inputs (RX) for monitoring, transmitting (TX) and considers (both RX & TX) scenarios. Computation of the scoring may include generation of visibility opportunities between specified transceiver antennas and RSOs and configured resources, azimuth/elevation/range generation, link budget analysis (for multiple antenna/aperture types and different signal processors, calculated power received by other RSOs and obscura crossing times. In some embodiments, workflow identifiers and guidance parameters may also be considered. The results of calculations are available to the scoring process where the process uses range and power for determining the most feasible options. These options are evaluated to select which COA will be used and which resource will be scheduled for its autonomous execution.

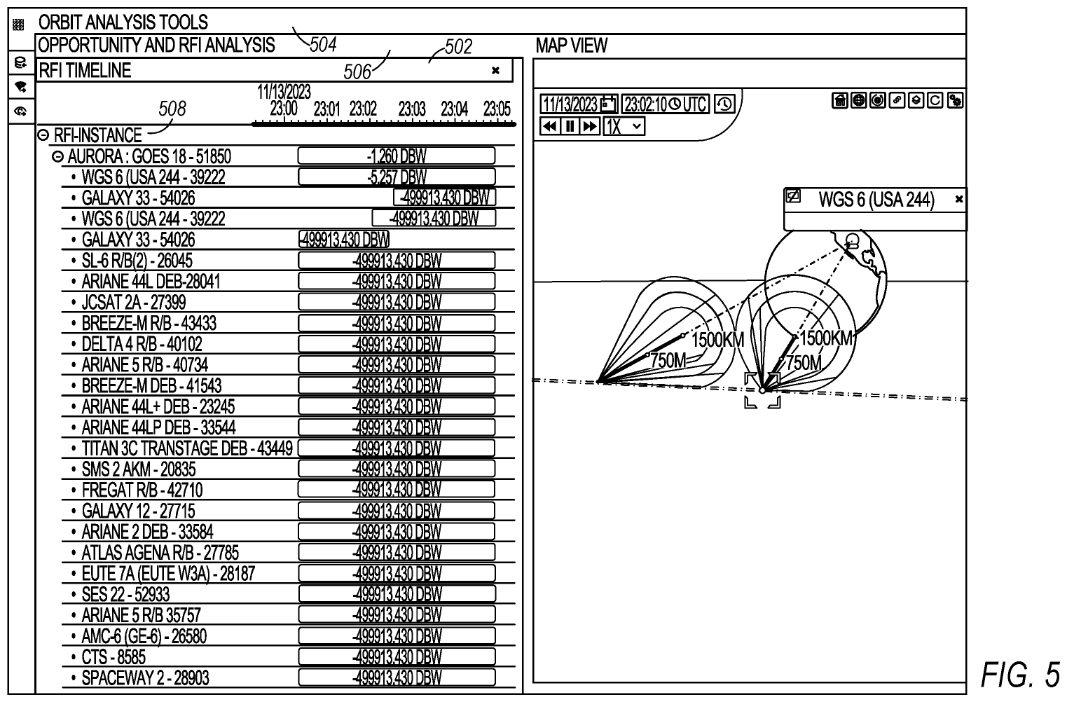

FIG. 5 illustrates an example display 500 with scored list according to aspects of the disclosure. The display 500 can be generated by the RF prediction engine 206 for display to ground station operators, RSO operators, etc. Timeline 502 illustrates a timeline for which scheduling is being generated. For example, RFI instances 504 within timeline 502 are shown in a list and each possible RFI instance could provide interference to an intended transceiver antenna.

The list 504 can be provided in a rank based on the likelihood interference will occur. For example, potential interferer 506 is highly likely to cause interference and scheduling or other avoidance techniques (e.g., contact plans) can be generated. Potential interferer may be shown in an alert color, e.g., red, for distinguishing potential interferer 506 from others in the list 504. Other possible interferers 508 can be similarly ranked. The potential interferers 508 may for example simply be within a field of regard of the intended transceiver antenna and have little or no likelihood of generating problematic interference. A map view 510 can be provided to show where interference is likely to occur. The list 504 and map view 510 can be periodically updated. In examples, geometric calculations may be updated on a different schedule than RFI power/frequency determinations are updated.

In examples, geometric calculations may be updated rarely and only based on detection or updates regarding new RSOs. In examples, only a subset of RSOs may be analyzed, based on request from a ground station or RSO operator. In examples, multi-core CPUs or GPUs can generate geometric calculations at an initial point and perform periodic updates. In other examples, only a small subset of potential interferers (e.g., those owned by a blacklisted country, etc.) may be analyzed. If interference is experienced, then a detailed assessment can be made of the situation and more RSOs can be analyzed regarding antenna field of regard angles, frequency, and TX power, when known.

Example embodiments can leverage cloud scalability to bring many CPU and/or GPU cores into use for geometric and other processing-intensive calculations. In cases in which potential interferer information is not completely known, interferers can be modeled based on observable information such as size. As interferers move into the ionosphere or higher, example methods according to embodiments can help mitigate interference or spying by scheduling transmit opportunities to avoid interference and spying.

Some embodiments of the present disclosure may be implemented in the form of processes and circuits for practicing those processes. Some embodiments of the present disclosure may also be implemented in the form of program code embodied in tangible media, such as magnetic recording media, optical recording media, memory devices, hard drives, or any other machine-readable storage medium.

### Example Method

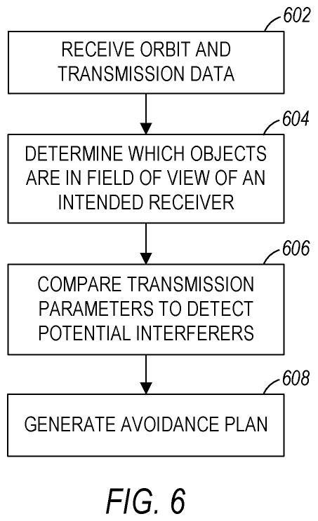

FIG. 6 is a flow chart of an example method 600 according to embodiments. The method 600 can be performed by processors (e.g., RF prediction engine 206 or any component of FIG. 6, which can include a plurality of processing cores or other processing elements.

In some embodiments, the method 600 may be started by data upload or by an artificial intelligence (AI)/Machine leaning (ML) engine/model/process. In some embodiments, the process is started every orbit revolution (assuming no new data has been received since the start of the last revolution).

Method 600 can begin with operation 602 with retrieving orbit and transmission data for a plurality of space and ground object. This data can be retrieved from known or available space catalogs, from national or organizational space services, etc.

Method 600 can continue with operation 604 with determining which of the space and ground objects are within a field of view of a receive antenna based on geometric calculations, to generate a set of potential interferers. The geometric calculations can be updated periodically or on demand as space or ground objects are added or removed.

Method 600 can continue with operation 606 with comparing transmission parameters of the set of potential interferers with corresponding parameters for an intended emitter to determine which of the set of potential interferers are expected to generate at least a threshold interference level. These transmission parameters can include frequency, beamwidth and transmit power for the potential interferers and the intended emitter, among other parameters. When frequency of a potential interferer is unknown then the method 600 can include determining a transmit power required to interfere at each possible frequency range.

Method 600 can continue with operation 608 with preparing an avoidance plan for avoiding interference with the potential interferers that are expected to exceed the threshold interference level. The method 600 can further include determining whether potential interferer emitted power can interfere with the receive antenna based on receive antenna sensitivity and link budget between the receive antenna and the intended emitter. In examples, for example if full details of a potential interferer are not known, estimations and predictions can be made based on a Bessel model of the potential interferer.

By implementing method 600 or similar methods in systems according to embodiments described above, spacecraft, satellites, and other communications systems can plan communications windows or avoidance windows around potential interferers, whether inadvertent or intentional interferers, in a timely manner, periodically or on demand as potential interferers are added or removed from a system.

### Additional Machine Components

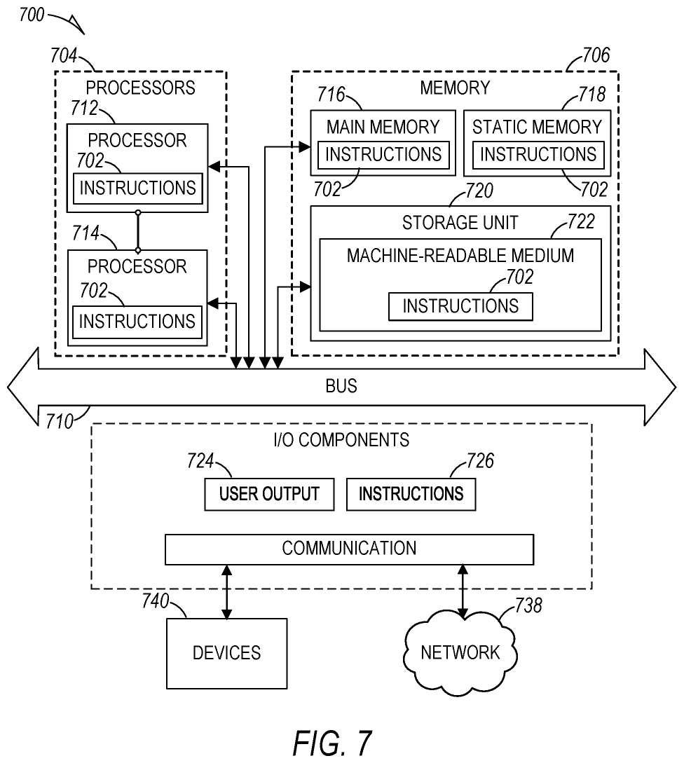

FIG. 7 is a diagrammatic representation of the machine 700 in which example embodiments can be implemented. The machine 700 can include processing circuitry 704, which can perform any function shown in FIG. 2 for example functions of RF prediction engine 206. For example, the processing circuitry 704 can include a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof.

The instructions 702 may cause the system 700 to execute any one or more of the methods described herein. The machine 700 may operate as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. Further, while a single machine 700 is illustrated, the term “machine” shall also be taken to include a collection of machines that individually or jointly execute the instructions 702 to perform any one or more of the methodologies discussed herein. The machine 700, for example, may comprise any of the processors or processing elements described above for processing CPIs to detect moving targets, for example, vehicles or other objects moving on the ground or at sea, for example.

The machine 700 may include memory 706, and input/output I/O components 708, which may be configured to communicate with each other via a bus 710.

The memory 706 includes a main memory 716, a static memory 718, and a storage unit 1020, both accessible to the processors 704 via the bus 710. The main memory 706, the static memory 718, and storage unit 1020 store the instructions 702 embodying any one or more of the methodologies or functions described herein. The instructions 702 may also reside, completely or partially, within the main memory 716, within the static memory 718, within non-transitory computer-readable storage medium 1022 within the storage unit 1020, within at least one of the processors 704 (e.g., within the processor's cache memory), or any suitable combination thereof, during execution thereof by the machine 700.

The I/O components 708 may include a wide variety of components to receive input, provide output, produce output, transmit information, exchange information, capture measurements, and so on. In various examples, the I/O components 708 may include user output components 724 and user input components 726. The user output components 724 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 726 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

Communication may be implemented using a wide variety of technologies. The I/O components 708 further include communication components 736 operable to couple the machine 700 to a network 738 or devices 740 via respective coupling or connections. For example, the communication components 736 may include a network interface component or another suitable device to interface with the network 738. In further examples, the communication components 736 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 740 may be another machine or any of a wide variety of peripheral devices (e.g., a peripheral device coupled via a USB).

The various memories (e.g., main memory 716, static memory 718, and memory of the processors 704) and storage unit 1020 may store one or more sets of instructions and data structures (e.g., software) embodying or used by any one or more of the methodologies or functions described herein. These instructions (e.g., the instructions 702), when executed by processors 704, cause various operations to implement the disclosed examples.

The instructions 702 may be transmitted or received over the network 738, using a transmission medium, via a network interface device (e.g., a network interface component included in the communication components 736) and using any one of several well-known transfer protocols (e.g., hypertext transfer protocol (HTTP)). Similarly, the instructions 702 may be transmitted or received using a transmission medium via a coupling (e.g., a peer-to-peer coupling) to the devices 740.

Technical effects include improved radar detection systems that can detect moving targets at increased range while using less computational power. Inter-processor communication is reduced by making use of memory on each processor to separately store detection information. Sparsification is achieved by reducing the amount of data in radar images to a list of potential targets and hypothetical targets, with removal of the radar images and lists from memory as soon as the accompanying data has been handled.

What is claimed is:

1. A contact planning system comprising:
memory for storing orbit and transmission data for a plurality of space and ground objects; and
a processing system coupled to the memory, the processing system configured to:
determine which of the space and ground objects are within a field of view of a receive antenna based on geometric calculations, to generate a set of potential interferers;
compare transmission parameters of the set of potential interferers with corresponding parameters for an intended emitter to determine which of the set of potential interferers are expected to generate at least a threshold interference level;
prepare an avoidance plan for avoiding interference with potential interferers that are expected to exceed the threshold interference level; and
encode signals for transmission to one or more of the space and ground objects for execution of the avoidance plan.

2. The contact planning system of claim 1, wherein the processing system is further configured to determine whether potential interferer emitted power can interfere with the receive antenna based on receive antenna sensitivity and link budget between the receive antenna and the intended emitter.

3. The contact planning system of claim 2, wherein the processing system is further configured to determine whether potential interferer emitted power can interfere with the receive antenna based on a Bessel model of the potential interferer using a detected antenna size of the potential interferer.

4. The contact planning system of claim 3, wherein the processing system is further configured to determine whether potential interferer emitted power can interfere with the receive antenna based on antenna information of the potential interferer.

5. The contact planning system of claim 4, wherein the transmission parameters include one or more of frequency, beamwidth and transmit power for the potential interferers and the intended emitter.

6. The contact planning system of claim 5, wherein for a potential interferer having an unknown frequency, the processing system is configured to determine transmit power to interfere at each possible frequency range.

7. The contact planning system of claim 1, wherein the processing system comprises multiple processor cores.

8. The contact planning system of claim 7, wherein the processing system comprises a graphics processing unit (GPU).

9. A method performed by one or more processors configured for operation in a contact planning system, the method comprising:
retrieving orbit and transmission data for a plurality of space and ground objects;
determining which of the space and ground objects are within a field of view of a receive antenna based on geometric calculations, to generate a set of potential interferers;
comparing transmission parameters of the set of potential interferers with corresponding parameters for an intended emitter to determine which of the set of potential interferers are expected to generate at least a threshold interference level;
preparing an avoidance plan for avoiding interference with the potential interferers that are expected to exceed the threshold interference level; and
encoding signals for transmission to one or more of the space and ground objects for execution of the avoidance plan.

10. The method of claim 9, further comprising determining whether potential interferer emitted power can interfere with the receive antenna based on receive antenna sensitivity and link budget between the receive antenna and the intended emitter.

11. The method of claim 10, further comprising determining whether potential interferer emitted power can interfere with the receive antenna based on a Bessel model of the potential interferer.

12. The method of claim 10, further comprising determining whether potential interferer emitted power can interfere with the receive antenna based on antenna information of the potential interferer.

13. The method of claim 9, wherein the transmission parameters include one or more of frequency, beamwidth and transmit power for the potential interferers and the intended emitter.

14. The method of claim 9, wherein when frequency of a potential interferer is unknown then the method further comprising determining a transmit power to interfere at each possible frequency range.

15. The method of claim 9, further comprising updating geometric calculations and a corresponding set of potential interferers periodically.

16. The method of claim 15, further comprising detecting transmission parameters of the set of potential interferers periodically.

17. A non-transitory computer-readable storage medium that stores instructions for execution by one or more processors, cause the one or more processors to perform operations including:
retrieving orbit and transmission data for a plurality of space and ground objects;
determining which of the space and ground objects are within a field of view of a receive antenna based on geometric calculations, to generate a set of potential interferers;
comparing transmission parameters of the set of potential interferers with corresponding parameters for an intended emitter to determine which of set of potential interferers are expected to generate at least a threshold interference level;
preparing an avoidance plan for avoiding interference with the potential interferers that are expected to exceed the threshold interference level; and
encoding signals for transmission to one or more of the space and ground objects for execution of the avoidance plan.

18. The non-transitory computer-readable storage medium of claim 17, wherein the operations further comprise determining whether potential interferer emitted power can interfere with the receive antenna based on receive antenna sensitivity and link budget between the receive antenna and the intended emitter.

19. The non-transitory computer-readable storage medium of claim 18, wherein the operations further comprise determining whether potential interferer emitted power can interfere with the receive antenna based on a Bessel model of the potential interferer.

20. The non-transitory computer-readable storage medium of claim 17, wherein the transmission parameters include one or more of frequency, beamwidth and transmit power for the potential interferers and the intended emitter, and
wherein when frequency of a potential interferer is unknown, then the operations further comprise determining the transmit power to interfere at each possible frequency range.
